(19) United States
(12) Patent Application Publication
(10) Pub. No.: US 2026/0083144 A1
(43) Pub. Date: Mar. 26, 2026

(54) HUMAN MILK FORTIFIER

(71) Applicant: Saurin Enterprises PL, Port Melbourne (AU)

(72) Inventors: Rakesh Aggarwal, Port Melbourne (AU); Saurabh Aggarwal, Koramangala (IN)

(21) Appl. No.: 19/406,778

(22) Filed: Dec. 2, 2025

Related U.S. Application Data
(62) Division of application No. 17/496,594, filed on Oct. 7, 2021.
Application No. 17/496,594 is a continuation-in-part of application No. 16/781,149, filed on Feb. 4, 2020, now abandoned.

(30) Foreign Application Priority Data
Feb. 7, 2019 (IN) 201911004925

(51) Int. Cl. A23C 9/158; A23C 9/142; A23C 9/15; A23C 9/152; A23C 9/16; A23C 9/20

(52) U.S. Cl. CPC A23C 9/158; A23C 9/1422; A23C 9/1512; A23C 9/1526; A23C 9/1528; A23C 9/16; A23C 9/206

(57) ABSTRACT

The present disclosure provides a human milk fortifier product composition with, a protein component in the milk fortifier in an amount ranging from 6 wt/wt % to 35 wt/wt % on solids basis; a fat component in the in the milk fortifier in an amount ranging from 0.1 wt/wt % to 36 wt/wt % on solids basis; a carbohydrate in the milk fortifier selected from the group of Lactose and Oligosaccharides present in the in an amount from 25 wt/wt % to 75 wt/wt % on solids basis; small molecules consisting of Oligosaccharides in the human milk fortified by the said fortifier is at least 25% more than the human milk alone. The majority of small molecules consisting of Vitamin A, Vitamin D, Vitamin E, LCPUFA, Epidermal growth factor and many others are retained in the fortifier product.

### PRIORITY CLAIM AND CROSS-REFERENCE TO RELATED APPLICATIONS

This application is a continuation-in-part of U.S. patent application Ser. No. 16/781,149, filed on Feb. 4, 2020, which claims priority to Indian Patent Application number 201911004925, filed Feb. 7, 2019, the contents of each of which are hereby incorporated by reference and relied upon.

### FIELD

The present disclosure provides a human milk fortifier in powder or liquid form. The human milk fortifier is rich in protein, energy and other nutrients, and may be derived from human milk. The present disclosure further provides methods of making the human milk fortifier.

### BACKGROUND

Human milk is commonly known as the best nutrition for the infant from its nutritional composition and immunologic benefits. Because human milk is full of nutrients, it is generally considered the ideal food for babies. However, studies in recent past suggested that the human milk of pre-term mother does not deliver sufficient amount of protein and other nutrients for pre-term children.

It is a long felt need to increase the amount of nutrients in the human milk and deliver a fortified milk rich in protein and other nutrients. When human milk is fortified with protein and energy, premature children, and/or normal infants consuming such milk may have rapid growth and it better meets the nutritional needs.

With such benefits of fortified milk, among other nutrients, protein content needs to be increased to meet the needs of pre-term children as per the recommendations of ESPGHAN (European Society for Paediatric Gastroenterology, Hepatology and Nutrition).

There is a human milk fortifier product already in the market with a composition of main three ingredients (Fat, protein and lactose) produced by ultrafiltration of the milk up to 8 times. However, ultrafiltration—especially multiple ultrafiltration steps—removes a majority of the beneficial small molecules present in the milk starting material. These beneficial small molecules lost to ultrafiltration processes include but not limited to Oligosaccharides, Vitamin A, Vitamin D, Vitamin E, Lactose, LCPUFA (long-chain polyunsaturated fatty acids), and Epidermal growth factor. A need persists for a milk fortifier, and especially a milk fortifier that is derived from human milk, that includes beneficial small molecules such as these.

### SUMMARY

The present disclosure provides milk fortifiers and fortified human milk products that include beneficial small molecule nutrients lost to ultrafiltration processes like Oligosaccharides, Vitamin A, Vitamin D, Vitamin E, LCPUFA, Epidermal growth factor. In one embodiment, the small molecules are recovered from ultrafiltration permeate and blended with the retentate of ultrafiltration. This human milk fortifier, when added to human milk, increases the total naturally occurring oligosaccharides content of the mixed milk compared to untreated human milk.

The present disclosure provides a formulation and techniques/method to produce a fortifier that has a high protein content and the small molecules including Oligosaccharides, Vitamin A, Vitamin D, Vitamin E, LCPUFA, Epidermal growth factor and many others. This fortifier, when mixed with the mother's own milk, provides an enhanced human milk composition that meets the ESPGHAN recommendation. The process includes physically separating milk components to produce a fortifier that is rich (e.g., enhanced) in protein compared to natural human milk. In some embodiments, the process does not include chemical reactions or the use of chemical solvents, resulting in a fortifier that is healthy for infants.

The present disclosure also provides a process that removes mainly lactose from human milk, while all other components of the milk—including beneficial small molecules like Oligosaccharides, Vitamin A, Vitamin D, Vitamin E, LCPUFA, Epidermal growth factor and many others—are retained in the milk retentate blend.

In some embodiments, the present disclosure provides a human milk fortifier product composition comprising a protein component in the milk fortifier in an amount ranging from 6 wt/wt % to 35 wt/wt % on solids basis; a fat component in the in the milk fortifier in an amount ranging from 0.1 wt/wt % to 36 wt/wt % on solids basis; a carbohydrate in the milk fortifier selected from the group of Lactose and Oligosaccharides present in the in an amount from 25 wt/wt % to 75 wt/wt % on solids basis; small molecules consisting of Oligosaccharides in the human milk fortified by the said fortifier is at least 25% more than the human milk alone.

In another embodiment, the milk fortifier includes a majority of small molecules present in natural human milk, including at least Vitamin A, Vitamin D, Vitamin E, LCPUFA, and Epidermal growth factor. In some embodiments, the small molecules present in the fortifier are derived from human milk.

The present invention discloses a manufacturing process to manufacture the human milk fortifier product composition of this invention using a process comprising the steps of:
a) pooling milk (e.g., human milk) obtained from multiple sources;
b) separating fat from the pooled milk to produce a skimmed milk;
c) optionally microfiltering the skimmed milk;
d) pasteurizing the skimmed milk;
e) Ultrafiltering the pasteurized skim milk resulting in a retentate including concentrated protein; and a permeate;
f) diafiltering the retentate to further concentrate protein;
g) Concentrating the diafiltered permeate using vacuum evaporation followed by cooling of the permeate to crystalize lactose;
h) Separating the lactose crystals from the liquid permeate to recover the essential nutrients with low molecular weight (e.g., beneficial small molecules) in a filtrate;
i) Repeating steps g and h above on the filtrate remove additional lactose from the filtrate;
j) Combining the filtrate with the retentate from step e to create a blend;
k) Optionally adding cream, lactose and/or other minerals and nutrients to the blend to achieve a specific desired final composition;
l) optionally concentrating the blend or desired final composition at low temperature, or at a temperature between 45° C.-85° C., to provide a concentrated blend having 40%-75% total solids wt./wt; and
m) optionally drying the concentrated blend using freeze drying or lyophilisation to produce a milk fortifier;
Human milk fortifiers consistent with the present disclosure may be produced in either dry powdered form or in liquid form.

The liquid form of the human milk fortifier product composition consistent with the present disclosure may be produced by skipping the concentrating and drying the blend steps (e.g., steps l and m above) to produce a liquid form of human milk fortifier having total solids at a concentration of 10%-60% w/v.

### BRIEF DESCRIPTION OF THE DRAWINGS

FIG. 1 shows an example process for making a milk fortifier consistent with one embodiment of the present disclosure.

### DETAILED DESCRIPTION

Incorporated herein, all publications, patents and patent applications, including any drawings and appendices by reference to the same extent as if each individual publication or patent application was specifically and individually indicated by reference incorporated.

Unless the context clearly dictates otherwise, the singular forms otherwise used herein and in the appended claims, “a”, “an” and “the” include plural referents. Thus, for example, reference to “a sample” includes a plurality of such samples, and reference to “the protein” includes reference to one skilled in the art or more proteins and the like.

Unless defined otherwise, all technical and scientific terms used herein have the same meaning in the art to which this invention belongs one of ordinary skill in the art as commonly understood. Although methods and materials may be used as described herein with similar or equivalent methods and materials in the practice of the method and compositions of the present invention, this article describes exemplary methods, devices and materials.

Certain features of claimed subject matter have been illustrated as described herein, many modifications, substitutions, changes and equivalents will now occur to those skilled in the art. It is, therefore, to be understood that the appended claims are intended to cover all such embodiments and changes as fall within the true spirit of claimed subject matter.

It is an object of the invention to provide a product with composition of protein, fat, carbohydrate.

In another object of the invention the product prepared in this invention is in powder or liquid form.

In yet another object of the invention, the product prepared in this invention recovers and retain most of the nutrients from permeate (which is the by-product of protein concentration process) and blended back to the protein concentrate.

In yet another object of the invention, the product prepared in this invention is a human milk fortifier.

The present invention provides a formulation and method to produce up to nine-fold concentrated protein rich human milk fortifier in liquid or dried form. The techniques employed in the invention are novel and have never been used to manufacture human milk fortifier from human milk before.

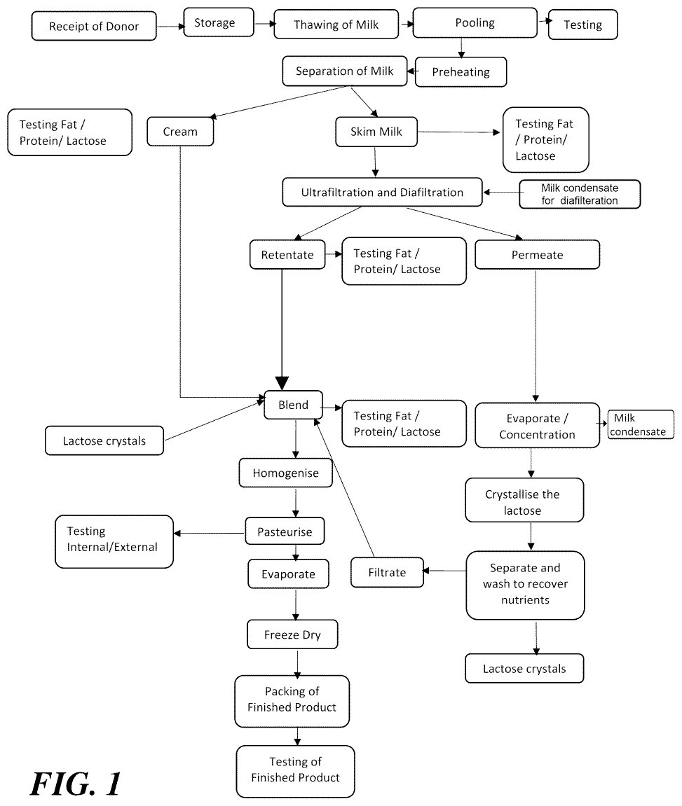

As an embodiment of the present disclosure, the human milk fortifier composition in this invention is produced by following a method. To illustrate the method of such production, an example for reference has been provided below. This method is also described under flowchart FIG. 1 of this application.

Referring now to FIG. 1, a method of making a fortified milk product (“Finished Product”) may begin by obtaining donor milk, such as donor human milk. The donor milk may be stored, for example as frozen donor milk, until sufficient donor milk is available for economical processing. Donor milk may be pooled and optionally tested before processing, for example to identify amounts of individual compounds or classes of compounds present in the donor milk.

The pooled donor milk may be preheated at conditions well-known to those of ordinary skill in the art to separate the donor milk into a thicker cream (using a mechanical separator) and a relatively more fluid skim milk component. The cream is separated from the skim milk. Each or both of these separated components—namely skim milk and cream—may be tested to determine amounts of fat, protein, and lactose present.

Optionally, the pooled donor milk may be subject to a microfiltration process, for example if the pooled milk includes or potentially includes an unacceptable level of bacteria and/or virus. Generally, microfiltration may be accomplished by filtration through a membrane having a pore size of about 0.1 microns to about 5 microns.

The skim milk is subjected to ultrafiltration followed by diafiltration to generate a permeate and a retentate. In some embodiments, the diafiltration step uses the same or similar filtration membrane used in the ultrafiltration step, and occurs at a pressure of about 2 bar to about 6 bar, for example about 2 bar, about 2.5 bar, about 3 bar, about 3.5 bar, about 4 bar, about 4.5 bar, about 5 bar, about 5.5 bar, or about 6 bar, and at a temperature of not more than about 60° C. using a diafiltration membrane such as a flat sheet, a spiral membrane, a ceramic membrane, or any other suitable diafiltration membrane. In some embodiments, milk condensate is added to the retentate and the process of ultrafiltration is repeated.

The skim milk layer may additionally be subject to an ultrafiltration step, for example to concentrate the protein content. When used, the ultrafiltration step may occur at 2-6 bar pressure and 10° C. to 60° C. temperature using a membrane having a molecular weight cutoff (MWCO) of about 1,000 kDa to about 30,000 kDa.

The permeate left over from diafiltration generally includes several small molecules that are beneficial (e.g., nutritious) and are typically not found in sufficient quantities in currently available fortified milk products. In some embodiments, the permeate is concentrated (e.g., by evaporation at ambient or elevated temperature). Lactose may be selectively removed from the permeate by crystallization. In some embodiments, the crystallization is accomplished by reducing the temperature of the concentrated permeate to about 20° C. or less at a controlled, relatively slow rate. Optionally, lactose seed crystals may be used to initiate or enhance crystallization. In some embodiments, crystallization occurs by reducing the temperature of the permeate to about 4° C. to about 20° C., for example about 4° C., about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., about 20° C., for a period of time of about 6 hours to about 24 hours.

Once crystallized, the lactose can be filtered from the permeate, and the lactose crystals may be washed to flush desirable small molecules back into the permeate (now referred to as the filtrate). The filtrate may be subjected to crystallization/filtration conditions one or more additional times to remove more lactose from the filtrate, if desired.

The filtrate, now including a relatively higher concentration of desirable small molecules like oligosaccharides, Vitamin A, Vitamin D, Vitamin E, LCPUFA, and Epidermal growth factor, and a relatively low concentration of lactose, is then mixed with the retentate from the diafiltration step to form a blend. Optionally, cream and/or lactose crystals may be added to the blend to produce a standardized product.

The blend obtained from the retentate may include a portion of the cream layer and/or lactose crystals, for example to improve consistency of the blend, and ultimately the finished product(s). The blend (optionally including added cream layer and/or lactose crystals) may then be homogenized, for example by a single stage or two-stage process. Homogenization may occur at a temperature of about 40° C. to about 60° C. and at a pressure of about 1,000 psi to about 2,500 psi.

Once homogenized, the blend may be pasteurized to reduce or eliminate the presence of harmful bacteria. For example, the blend may be subjected to a process consistent with the U.S. Department of Health and Human Services, Food and Drug Administration's “Grade A Pasteurized Milk Ordinance,” 2017 Revision, incorporated herein by reference, or similar process. The pasteurized blend may be tested, for example to determine the amounts of one or more components or classes of components.

The pasteurized blend may be concentrated, such as by evaporation, to increase the amounts of desirable compounds or classes of compounds in the blend. If the goal is to make a liquid fortifier, the method may conclude when the concentration step provides a liquid blend having one or more of:
(i) a protein component in an amount of about 6 wt/wt % to 35 wt/wt % on solids basis, for example about 6 wt/wt %, about 7 wt/wt %, about 8 wt/wt %, about 9 wt/wt %, about 10 wt/wt %, about 11 wt/wt %, about 12 wt/wt %, about 13 wt/wt %, about 14 wt/wt %, about 15 wt/wt %, about 16 wt/wt %, about 17 wt/wt %, about 18 wt/wt %, about 19 wt/wt %, about 20 wt/wt %, about 21 wt/wt %, about 22 wt/wt %, about 23 wt/wt %, about 24 wt/wt %, about 25 wt/wt %, about 26 wt/wt %, about 27 wt/wt %, about 28 wt/wt %, about 29 wt/wt %, about 30 wt/wt %, about 31 wt/wt %, about 32 wt/wt %, about 33 wt/wt %, about 34 wt/wt %, or about 35 wt/wt % on a solids basis;
(ii) a fat component in an amount of about 0.1 wt/wt % to about 36 wt/wt % on solids basis, for example about 0.1 wt/wt %, about 0.2 wt/wt %, about 0.3 wt/wt %, about 0.4 wt/wt %, about 0.5 wt/wt %, about 0.6 wt/wt %, about 0.7 wt/wt %, about 0.8 wt/wt %, about 0.9 wt/wt %, about 1 wt/wt %, about 1.1 wt/wt %, about 1.2 wt/wt %, about 1.3 wt/wt %, about 1.4 wt/wt %, about 1.5 wt/wt %, about 1.6 wt/wt %, about 1.7 wt/wt %, about 1.8 wt/wt %, about 1.9 wt/wt %, about 2 wt/wt %, about 2.1 wt/wt %, about 2.2 wt/wt %, about 2.3 wt/wt %, about 2.4 wt/wt %, about 2.5 wt/wt %, about 2.6 wt/wt %, about 2.7 wt/wt %, about 2.8 wt/wt %, about 2.9 wt/wt %, about 3 wt/wt %, about 3.1 wt/wt %, about 3.2 wt/wt %, about 3.3 wt/wt %, about 3.4 wt/wt %, about 3.5 wt/wt %, about 3.6 wt/wt %, about 3.7 wt/wt %, about 3.8 wt/wt %, about 3.9 wt/wt %, about 4 wt/wt %, about 4.1 wt/wt %, about 4.2 wt/wt %, about 4.3 wt/wt %, about 4.4 wt/wt %, about 4.5 wt/wt %, about 4.6 wt/wt %, about 4.7 wt/wt %, about 4.8 wt/wt %, about 4.9 wt/wt %, about 5 wt/wt %, about 5.5 wt/wt %, about 6 wt/wt %, about 6.5 wt/wt %, about 7 wt/wt %, about 7.5 wt/wt %, about 8 wt/wt %, about 8.5 wt/wt %, about 9 wt/wt %, about 9.5 wt/wt %, about 10 wt/wt %, about 11 wt/wt %, about 12 wt/wt %, about 13 wt/wt %, about 14 wt/wt %, about 15 wt/wt %, about 16 wt/wt %, about 17 wt/wt %, about 18 wt/wt %, about 19 wt/wt %, about 20 wt/wt %, about 21 wt/wt %, about 22 wt/wt %, about 23 wt/wt %, about 24 wt/wt %, about 25 wt/wt %, about 26 wt/wt %, about 27 wt/wt %, about 28 wt/wt %, about 29 wt/wt %, about 30 wt/wt %, about 31 wt/wt %, about 32 wt/wt %, about 33 wt/wt %, about 34 wt/wt %, about 35 wt/wt %, or about 36 wt/wt % on a solids basis;
(iii) carbohydrates (e.g., Lactose and/or Oligosaccharides) in an amount of about 25 wt/wt % to about 75 wt/wt % on solids basis, for example about 25 wt/wt %, about 26 wt/wt %, about 27 wt/wt %, about 28 wt/wt %, about 29 wt/wt %, about 30 wt/wt %, about 31 wt/wt %, about 32 wt/wt %, about 33 wt/wt %, about 34 wt/wt %, about 35 wt/wt %, about 36 wt/wt %, about 37 wt/wt %, about 38 wt/wt %, about 39 wt/wt %, about 40 wt/wt %, about 41 wt/wt %, about 42 wt/wt %, about 43 wt/wt %, about 44 wt/wt %, about 45 wt/wt %, about 46 wt/wt %, about 47 wt/wt %, about 48 wt/wt %, about 49 wt/wt %, about 50 wt/wt %, about 51 wt/wt %, about 52 wt/wt %, about 53 wt/wt %, about 54 wt/wt %, about 55 wt/wt %, about 56 wt/wt %, about 57 wt/wt %, about 58 wt/wt %, about 59 wt/wt %, about 60 wt/wt %, about 61 wt/wt %, about 62 wt/wt %, about 63 wt/wt %, about 64 wt/wt %, about 65 wt/wt %, about 66 wt/wt %, about 67 wt/wt %, about 68 wt/wt %, about 69 wt/wt %, about 70 wt/wt %, about 71 wt/wt %, about 72 wt/wt %, about 73 wt/wt %, about 74 wt/wt %, or about 75 wt/wt % on a solids basis;
(iv) Oligosaccharides in an amount of at least 25% more than present in the donor milk; and/or:

(v) Oligosaccharides, Vitamin A, Vitamin D, Vitamin E, LCPUFA, and/or Epidermal growth factor in concentration greater than the donor milk, for example at least 1%, at least 2%, at least 3%, at least 4%, at least 5%, at least v6%, at least 7%, at least 8%, at least 9%, at least 10%, at least 11%, at least 12%, at least 13%, at least 14%, at least 15%, at least 16%, at least 17%, at least 18%, at least 19%, at least 20%, or more than 20% greater than the donor milk.

If the goal is to prepare a solid (e.g., powdered) milk fortifier, then the concentrated blend may be further subjected to freeze drying conditions to prepare a powdered (e.g., lyophilized) fortifier. For example and without limitation, the concentrated blend may be freeze dried to form a freeze-dried or lyophilized fortifier having one or more of:
(i) a protein component in an amount of about 6 wt/wt % to 35 wt/wt % on solids basis, for example about 6 wt/wt %, about 7 wt/wt %, about 8 wt/wt %, about 9 wt/wt %, about 10 wt/wt %, about 11 wt/wt %, about 12 wt/wt %, about 13 wt/wt %, about 14 wt/wt %, about 15 wt/wt %, about 16 wt/wt %, about 17 wt/wt %, about 18 wt/wt %, about 19 wt/wt %, about 20 wt/wt %, about 21 wt/wt %, about 22 wt/wt %, about 23 wt/wt %, about 24 wt/wt %, about 25 wt/wt %, about 26 wt/wt %, about 27 wt/wt %, about 28 wt/wt %, about 29 wt/wt %, about 30 wt/wt %, about 31 wt/wt %, about 32 wt/wt %, about 33 wt/wt %, about 34 wt/wt %, or about 35 wt/wt % on a solids basis;
(ii) a fat component in an amount of about 0.1 wt/wt % to about 36 wt/wt % on solids basis, for example about 0.1 wt/wt %, about 0.2 wt/wt %, about 0.3 wt/wt %, about 0.4 wt/wt %, about 0.5 wt/wt %, about 0.6 wt/wt %, about 0.7 wt/wt %, about 0.8 wt/wt %, about 0.9 wt/wt %, about 1 wt/wt %, about 1.1 wt/wt %, about 1.2 wt/wt %, about 1.3 wt/wt %, about 1.4 wt/wt %, about 1.5 wt/wt %, about 1.6 wt/wt %, about 1.7 wt/wt %, about 1.8 wt/wt %, about 1.9 wt/wt %, about 2 wt/wt %, about 2.1 wt/wt %, about 2.2 wt/wt %, about 2.3 wt/wt %, about 2.4 wt/wt %, about 2.5 wt/wt %, about 2.6 wt/wt %, about 2.7 wt/wt %, about 2.8 wt/wt %, about 2.9 wt/wt %, about 3 wt/wt %, about 3.1 wt/wt %, about 3.2 wt/wt %, about 3.3 wt/wt %, about 3.4 wt/wt %, about 3.5 wt/wt %, about 3.6 wt/wt %, about 3.7 wt/wt %, about 3.8 wt/wt %, about 3.9 wt/wt %, about 4 wt/wt %, about 4.1 wt/wt %, about 4.2 wt/wt %, about 4.3 wt/wt %, about 4.4 wt/wt %, about 4.5 wt/wt %, about 4.6 wt/wt %, about 4.7 wt/wt %, about 4.8 wt/wt %, about 4.9 wt/wt %, about 5 wt/wt %, about 5.5 wt/wt %, about 6 wt/wt %, about 6.5 wt/wt %, about 7 wt/wt %, about 7.5 wt/wt %, about 8 wt/wt %, about 8.5 wt/wt %, about 9 wt/wt %, about 9.5 wt/wt %, about 10 wt/wt %, about 11 wt/wt %, about 12 wt/wt %, about 13 wt/wt %, about 14 wt/wt %, about 15 wt/wt %, about 16 wt/wt %, about 17 wt/wt %, about 18 wt/wt %, about 19 wt/wt %, about 20 wt/wt %, about 21 wt/wt %, about 22 wt/wt %, about 23 wt/wt %, about 24 wt/wt %, about 25 wt/wt %, about 26 wt/wt %, about 27 wt/wt %, about 28 wt/wt %, about 29 wt/wt %, about 30 wt/wt %, about 31 wt/wt %, about 32 wt/wt %, about 33 wt/wt %, about 34 wt/wt %, about 35 wt/wt %, or about 36 wt/wt % on a solids basis;
(iii) carbohydrates (e.g., Lactose and/or Oligosaccharides) in an amount of about 25 wt/wt % to about 75 wt/wt % on solids basis, for example about 25 wt/wt %, about 26 wt/wt %, about 27 wt/wt %, about 28 wt/wt %, about 29 wt/wt %, about 30 wt/wt %, about 31 wt/wt %, about 32 wt/wt %, about 33 wt/wt %, about 34 wt/wt %, about 35 wt/wt %, about 36 wt/wt %, about 37 wt/wt %, about 38 wt/wt %, about 39 wt/wt %, about 40 wt/wt %, about 41 wt/wt %, about 42 wt/wt %, about 43 wt/wt %, about 44 wt/wt %, about 45 wt/wt %, about 46 wt/wt %, about 47 wt/wt %, about 48 wt/wt %, about 49 wt/wt %, about 50 wt/wt %, about 51 wt/wt %, about 52 wt/wt %, about 53 wt/wt %, about 54 wt/wt %, about 55 wt/wt %, about 56 wt/wt %, about 57 wt/wt %, about 58 wt/wt %, about 59 wt/wt %, about 60 wt/wt %, about 61 wt/wt %, about 62 wt/wt %, about 63 wt/wt %, about 64 wt/wt %, about 65 wt/wt %, about 66 wt/wt %, about 67 wt/wt %, about 68 wt/wt %, about 69 wt/wt %, about 70 wt/wt %, about 71 wt/wt %, about 72 wt/wt %, about 73 wt/wt %, about 74 wt/wt %, or about 75 wt/wt % on a solids basis;
(iv) Oligosaccharides in an amount of at least 25% more than present in the donor milk; and/or:
(v) Oligosaccharides, Vitamin A, Vitamin D, Vitamin E, LCPUFA, and/or Epidermal growth factor in concentration greater than the donor milk, for example at least 1%, at least 2%, at least 3%, at least 4%, at least 5%, at least v6%, at least 7%, at least 8%, at least 9%, at least 10%, at least 11%, at least 12%, at least 13%, at least 14%, at least 15%, at least 16%, at least 17%, at least 18%, at least 19%, at least 20%, or more than 20% greater than the donor milk.

The freeze drying step may, in some embodiments, comprise cooling the concentrated blend to a temperature of about −30° F. to about −50° F. (about −34° C. to about −46° C.) before placing the cold (e.g., frozen) blend under vacuum pressure conditions of about 500 m Torr. The temperature of the concentrated blend is then slowly warmed, enabling water in the concentrated blend to vaporize and/or evaporate. The step of freeze drying may occur over a period of about 24 hours to about 72 hours, such as about 24 hours, about 25 hours, about 26 hours, about 27 hours, about 28 hours, about 29 hours, about 30 hours, about 31 hours, about 32 hours, about 33 hours, about 34 hours, about 35 hours, about 36 hours, about 37 hours, about 38 hours, about 39 hours, about 40 hours, about 41 hours, about 42 hours, about 43 hours, about 44 hours, about 45 hours, about 46 hours, about 47 hours, about 48 hours, about 49 hours, about 50 hours, about 51 hours, about 52 hours, about 53 hours, about 54 hours, about 55 hours, about 56 hours, about 57 hours, about 58 hours, about 59 hours, about 60 hours, about 61 hours, about 62 hours, about 63 hours, about 64 hours, about 65 hours, about 66 hours, about 67 hours, about 68 hours, about 69 hours, about 70 hours, about 71 hours, about 72 hours, or more than about 72 hours.

Fortified milk products may be produced by first preparing a milk fortifier in either liquid or solid form consistent with the processes described representatively above. The milk fortifier may then be combined with milk to prepare a fortified milk product having enhanced levels of (i) protein, (ii) fat, (iii) carbohydrates, (iv) oligosaccharides, and/or (v) beneficial small molecules such as any one or more of: Oligosaccharides, Vitamin A, Vitamin D, Vitamin E, LCPUFA, and Epidermal growth factor.

In some embodiments, a composition of the present disclosure comprises an enhanced level of lactoferrin compared to raw human milk. In some embodiments, the composition comprises at least about 5% more, at least about 10% more, at least about 15% more, at least about 20% more, at least about 25% more, at least about 30% more, at least about 35% more, at least about 40% more, or at least about 50% more lactoferrin than raw human milk. In some embodiments, a fortifier of the present disclosure provides a fortified milk composition including an enhanced level of lactoferrin compared to raw human milk. In some embodiments, the composition comprises at least about 5% more, at least about 10% more, at least about 15% more, at least about 20% more, at least about 25% more, at least about 30% more, at least about 35% more, at least about 40% more, or at least about 50% more lactoferrin than raw human milk. The level of lactoferrin in the composition, in the fortified milk composition, and/or the comparative raw human milk may be determined by any suitable method including but not limited to the RP-HPLC method by Tsakali, et al., “A rapid HPLC method for the determination of Lactoferrin in milk of various species,” J. Dairy Res., 86 (2): 238-241 (2019), which is incorporated herein by reference in its entirety.

### EXAMPLES

In our process, we used the following steps:
1. Pooling;
2. Fat separation to produce skim milk (skim has fat typically less than 0.1%). We used centrifugal Separator but those skilled in the art may as well use other well know technologies to achieve the same objective;
3. Microfiltration: if deemed necessary/optional due to quality of milk;
4. Pasteurisation of the skim milk;
5. The process further uses ultrafiltration techniques to achieve protein concentration in the fortifier. The concentration can be multi fold; the present invention has performed up to 9 fold) using ultrafiltration. Further, the lactose content was reduced further by using diafiltration. In this example, we produced the final product by 4 times the concentration using ultrafiltration (The retentate volume was reduced to one fourth of the starting skim milk volume) followed by three cycles of diafilteration. The product thus concentrated is called ‘retentate’ of ultrafilteration process, referring to flowchart of FIG. 1. The other product is called ‘permeate’.
6. It is an objective of the invention to reduce lactose content thus increasing the protein content of the retentate on solids basis. It is understood that many nutrients that have a low molecular weight like Oligosaccharides, Vitamin A, Vitamin D, Vitamin E, LCPUFA, Epidermal growth factor and many others are lost with the permeate thus produced using ultrafiltration process while producing concentrated protein. Our objective is to reduce only lactose while concentrating other components of mothers milk. We use the crystallisation process which allows only pure crystals of lactose to be formed. Crystallization is a unique chemical solid-liquid separation technique, in which mass transfer of a solute from the liquid solution to a pure solid crystalline phase occurs. It is a very widely used method for manufacture of pure lactose whereas the lactose is crystallised by using a combination of concentration and temperature followed by washing of crystals. Using the process of crystallisation, we follow the following to steps recover majority of the nutrients lost in permeate:
   6.a) Concentrate the permeate using vacuum evaporator to 40 to 75% solids and allowed the lactose to crystalize by cooling the concentrated product.
   6.b) Further, the crystals were separated and washed using water to recover majority of the nutrients attached to the crystals.
   6.c) The filtrate was evaporated and concentrated again by using vacuum evaporator to further remove the lactose crystals by cooling the concentrated product.
   6.d) These were re-washed with water to recover the nutrients attached to the crystals. We used vacuum evaporator to concentrate but those skilled in the art may as well use other well-known technologies including membrane technology like Reverse Osmosis and Nano-filtration to achieve the same objective. The process of recovering more and more of lactose crystals thus reducing the lactose content in the final product can be repeated many times and includes concentration of filtrate, crystallising to lactose, washing of crystals and recovering the filtrate.
7. The filtrate thus recovered was mixed back with the retentate of the ultrafiltration process as described/produced in step 5 creating a blend.
8. This was followed by an optional blending operation to get the desired formulation. In blending operation, we may add back cream and lactose crystals to the blend. Optionally homogenisation can be done after blending.
9. Low temperature vacuum evaporation, preferably where the temperature of the blend stays within 45° C. and 63° C. during concentration of ultrafiltered retentate milk or the blend to 40 to 75% total solids. We used vacuum evaporator for concentration but those skilled in the art may as well use other well-known technologies to achieve the same objective.
10. Drying of the concentrated retentate milk or the blend using Freeze Drying also called lyophilisation. We used Freeze Dryer but those skilled in the art may as well use other well-known technologies of drying (like spray drying, tray drying, vacuum oven drying etc.) to achieve the same objective.
11. Further to freeze drying, we obtain a finished product with high in protein content and low lactose content.

It is an object of the invention, to provide a human milk fortifier by following the above explained methodical steps. The human milk fortifier is produced in preferably produced in dry powdered form and is also produced in liquid form as one of the embodiment of the invention. The concentrated retentate milk or the blend is not subjected to freeze drying and instead used as liquid form. Either a dry powdered production or a liquid production or a concentrate form will not alter the composition claimed/disclosed. It may be perceived as an alternative physical form of the claimed composition with the claimed method.

In an embodiment of the invention the above characteristics steps yield a milk fortifier with following compositions:
a protein component in the powdered milk fortifier and in the liquid form on solids basis is in an amount ranging from 6 wt/wt % to 35 wt/wt %;
a fat component in the in the powdered milk fortifier in an amount ranging from 0.1 wt/wt % to 36 wt/wt %;
a carbohydrate in the powdered milk fortifier selected from the group of Lactose and Oligosaccharides present in the in an amount from 25 wt/wt % to 75 wt/wt %.

The powder thus produced has undergone minimum processing, retains substantial essential nutrients like Oligosaccharides, Vitamin A, Vitamin D, Vitamin E, LCPUFA, Epidermal growth factor available naturally in mother's milk. This powder can fortify the mother's milk in protein and essential nutrients present naturally in mother's milk. As an illustrative reference for composition thus achieved in the powder produced are following:

TABLE 1

| | Gms/100 gms of powder |
|---|---|
| Fat | 10.98 |
| Protein | 28.56 |
| Lactose | 52.00 |
| Total Solids | 97.00 |

Another reference of composition made by adding 1 gms. of this powder to 25 mL of Pre-term mother's milk, we get the following composition.

TABLE 2

| | | Mother’s Milk + One |
|---|---|---|
| | Mother’s Milk | sachet of Mother’s Milk |
| | 25 mL³ | Fortifier of Example 2 |
| Fat in Gms | 0.9 | 1.01 |
| Protein in Gms | 0.4 | 0.69 |
| Carbohydrate in Gms | 1.8 | 2.30 |

Another reference of composition we produced in a powder form with the following composition consisting of a different blend are as follows:

TABLE 3

| | Gms/100 gms of powder |
|---|---|
| Fat | 30.37 |
| Protein | 29.80 |
| Lactose | 28.00 |
| Total Solids | 97.00 |

A fortifier including the levels of vitamins and nutrients shown in Table 4 below was produced by a method consistent with the present disclosure.

TABLE 4

| | | Unprocessed human | |
|---|---|---|---|
| Fortifier | | breast milk | Human milk |
| Component | Unit | (matured)/100 ml * | fortifier/g** |
| Vitamin A | μg | 58 | 1.95 |
| Vitamin D | μg | traces | 0.02 |
| Vitamin E | mg | 0.34 | 0.02 |
| 2′-fucosyllactose human | g | 0.27 *** | 0.029 |
| milk oligosaccharide | | | |
| (2’FL HMO) | | | |
| Nucleotides | | 68 μmol/L **** | 0.306 mg |

Ref:
* Food Standards Agency. McCance and Widdowson’s The Composition of Foods (7th summary ed.). Cambridge Royal Society of Chemistry, UK. Cambridge Royal Society Of Chemistry UK, 2015.
**product analysed values
***Human milk oligosaccharides influence neonatal mucosal and systemic immunity. (2015) Sharon M Donovan, Ann Nutr Metab
**** Thorell, L., Sjöberg, LB. & Hernell, O. Nucleotides in Human Milk: Sources and Metabolism by the Newborn Infant. Pediatr Res 40, 845-852 (1996).

Many doctors have criticised the liquid human milk fortifier already available on two main grounds. These are mainly:
(a) The product displaces mothers milk (while our Powder Fortifier does not displace the mother's milk at all) hence the essential nutrients available in mother's milk are reduced. To give an example, if the available human milk fortifier 50 ml is mixed with 50 ml of mother's milk, the baby will only receive the half of the essential nutrients equal to 50 mL of its own mother's milk.
(b) The available human milk fortifier loses a significant portion of naturally occurring Oligosaccharides, Vitamin A, Vitamin D, Vitamin E, LCPUFA, Epidermal growth factor in the mother's milk in the process of ultrafiltration which are not recovered and added back to the retentate.

The present invention/claimed human milk fortifier product composition not only retains majority of the small molecules like Oligosaccharides, Vitamin A, Vitamin D, Vitamin E, Lactose, LCPUFA, Epidermal growth factor but supplements what is available in Mothers milk already. To make 100 mL of fortified mothers milk, we add powder to 100 mL of mother's milk hence no displacement of mother's milk by fortifier.

We claim:

1. A method of making a fortified human milk composition, the method comprising:
a. pooling of a human milk;
b. separating fat to produce a skim milk from the pooled human milk;
c. microfiltering the skimmed milk;
d. pasteurizing the microfiltered skimmed milk;
e. ultrafiltering the pasteurized skimmed milk to provide a retentate consisting of concentrated protein and a permeate;
f. diafiltering the retentate to further concentrate the protein;
g. concentrating the permeate using vacuum evaporation followed by cooling to crystalize the lactose from the permeate;
h. washing the lactose crystals from the permeate to recover essential nutrients having low molecular weight and to provide a filtrate;
i. repeating steps g and h on the filtrate to remove additional lactose from the filtrate;
j. combining the filtrate with the retentate to produce a blend;
k. optionally adding cream, lactose and other minerals and nutrients to the blend to produce the human milk fortifier composition having 10% w/v to 60% w/v total solids;
l. concentrating the blend at a temperature of 45° C. to 85° C. to produce a concentrated blend having 40 to 75% solids; and
m. drying the concentrated blend using freeze drying or lyophilisation to produce a dry milk fortifier.

2. A process of manufacturing a human milk fortifier composition that comprises:
a protein component in an amount ranging from 6 wt/wt % to 35 wt/wt % on a solids basis;
a fat component in an amount ranging from 0.1 wt/wt % to 36 wt/wt % on solids basis; and
a carbohydrate selected from the group of Lactose and Oligosaccharides present in the milk fortifier composition in an amount from 25 wt/wt % to 75 wt/wt % on solids basis,
the method comprising:
a. pooling human donor milk;
b. separating fat from the pooled human donor milk to produce a skim milk;
c. optionally microfiltrating the skimmed milk
d. pasteurizing the skimmed milk;
e. ultrafiltrating the skim milk resulting into a retentate consisting of concentrate protein and a permeate; diafiltrating the milk to further concentrate protein;
f. concentrating the permeate using vacuum evaporation followed by cooling of the permeate to crystalize the lactose;
g. washing of lactose crystals from permeate resulting into recovering of the essential nutrients with low molecular weight;
h. following the step f and g above repeatedly on the filtrate thus recovered from permeate to remove lactose;
i. mixing back the filtrate with the retentate recovering essential nutrients in retentate and creating a blend; and
j. optionally adding cream, lactose and other minerals and nutrients to the blend to achieve a specific desired final composition.

3. The process of claim 2 further comprising concentrating the blend to 40 to 75% solid and drying the concentrated blend using freeze drying or lyophilisation to produce a milk fortifier.

4. The process of claim 2, wherein the blend is concentrated to 40%-75% total solids wt./wt. at a temperature between 45° C. and 85° C.

5. The process of claim 3, wherein the blend is concentrated to 40%-75% total solids wt./wt. at a temperature between 45° C. and 85° C.

6. The process of claim 4, wherein the steps of concentrating and drying the blend are skipped to produce a liquid form of human milk fortifier with a concentration of 10%-60% total solids w/v.

7. The process of claim 5, wherein the steps of concentrating and drying the blend are skipped to produce a liquid form of human milk fortifier with a concentration of 10%-60% total solids w/v.
